(19) United States
(12) Patent Application Publication
(10) Pub. No.: US 2014/0021901 A1
(43) Pub. Date: Jan. 23, 2014

(54) Driving circuit and method for fan

(71) Applicant: ANPEC ELECTRONICS CORPORATION, Hsin-Chu (TW)

(72) Inventors: Ching-Feng Lai, Taipei City (TW); Hung-Chun Yeh, Hsinchu City (TW); Kang Sheng, Taoyuan County (TW)

(73) Assignee: ANPEC ELECTRONICS CORPORATION, Hsin-Chu (TW)

(21) Appl. No.: 13/646,745

(22) Filed: Oct. 8, 2012

(30) Foreign Application Priority Data
Jul. 17, 2012 (TW) 101125689

(51) Int. Cl. H02P 7/29

(52) U.S. Cl. 318/503

(57) ABSTRACT

A driving circuit for a fan includes an initiation module for generating a switch signal according to a feedback signal, a control module coupled to the initiation module for generating a control signal according to the switch signal and a predetermined comparison signal, so as to drive the fan for a rotational operation, and a feedback module coupled to the fan for generating the feedback signal according to a conduction result of the fan, wherein the control module utilizes a pulse frequency modulation technique to generate the control signal, and the conduction result is realized via a voltage type or a current type to correspond to a rotational speed of the rotational operation.

### BACKGROUND OF THE INVENTION

1. Field of the Invention

The present invention relates to a driving circuit and method for a fan, and more particularly, to a driving circuit and method for a fan by utilizing a pulse frequency modulation technique to compare a conduction result of the fan and a predetermined comparison signal.

2. Description of the Prior Art

A motor is an electronic device for transferring electrical energy into dynamic energy, such as a DC motor, an AC motor or a stepper motor, etc. The DC motor is frequently utilized in non-sophisticated control devices, such as a fan. Generally, the DC motor rotates based on a current passing through coils of a stator of the DC motor to generate different amounts or polarized directions of magnetic force to attract or repel a permanent magnet on a rotor of the DC motor to make the motor rotate.

Please refer to FIG. 1, which illustrates a schematic diagram of a conventional motor driving circuit 10. As shown in FIG. 1, the motor driving circuit 10 utilizes a linear voltage driving process to correspondingly drive a fan 12 for rotation. The motor driving circuit 10 receives an input voltage source VIN, and a voltage dropping is correspondingly generated to render an output voltage VOUT to the fan 12, wherein the voltage dropping is a difference between the input voltage source VIN and the output voltage VOUT. Please refer to FIG. 2, which illustrates a detailed schematic diagram of the motor driving circuit 10 shown in FIG. 1, wherein the motor driving circuit 10 is an electrical chip circuit labeled APL5607. As shown in FIG. 2, the motor driving circuit 10 includes a soft start module 200 for receiving the input voltage source VIN, an enabling signal S_EN and a thermal signal S_TH and outputting a switch signal S_ST to a comparator 202.

The comparator 202 receives a reset signal S_RST and a feedback signal S_FB. Accordingly, a control module 204 correspondingly switches on/off a switch transistor 206. After the switch transistor 206 is turned on, the input voltage VIN is transformed into the output voltage VOUT to the fan 12, and a feedback module 208 adaptively transforms the output voltage VOUT into the feedback signal S_FB. Preferably, the feedback module 208 is realized by two division voltage resistors R1, R2, which renders corresponding resistances to transform the output voltage VOUT into the feedback signal S_FB. Besides, the enabling signal S_EN correspondingly turns on another switch transistor 210 via a resistor R3 and an inverter INV, which results in the generation of the output voltage VOUT to drive the fan 12 for rotation. Since the motor driving circuit 10 generates the linear voltage (i.e. the difference between the input voltage VIN and the output voltage VOUT) to drive the fan 12, a rotational speed of the fan 12 is adjusted to increase/decrease corresponding to the increases/decreases of the input voltage VIN. In that, there should be no other operational mechanisms or control signals to adaptively change the rotational speed of the fan 12, so as to match different users' requirements while the fan 12 is operated at different environmental conditions. Hence, the application of the motor driving circuit 10 is limited. On the other hand, heat generation accompanying with the operation of the motor driving circuit 10 may be inevitable and quite huge such that energy conversion efficiency of the motor driving circuit 10 can correspondingly decrease, so as to influence the operation of the fan 12.

Therefore, it has become an important issue to provide a driving circuit and method for a fan, which utilizes different operations and control signals to qualify for different requirements and environmental conditions, so as to avoid the heat generation which may decrease the energy conversion efficiency of the motor driving circuit 10 during the operation.

### SUMMARY OF THE INVENTION

It is therefore an objective of the invention to provide a driving circuit and method for a fan by utilizing a plurality of predetermined comparison signals to qualify for different users' requirements and environmental conditions.

The present invention discloses a driving circuit for a fan comprising an initiation module for generating a switch signal according to a feedback signal, a control module coupled to the initiation module for generating a control signal according to the switch signal and a predetermined comparison signal, so as to drive the fan for a rotational operation, and a feedback module coupled to the fan for generating the feedback signal according to a conduction result of the fan, wherein the control module utilizes a pulse frequency modulation technique to generate the control signal, and the conduction result is realized via a voltage type or a current type to correspond to a rotational speed of the rotational operation.

The present invention discloses another method for driving a driving circuit of a fan comprising generating a switch signal according to a feedback signal, utilizing a pulse frequency modulation technique to generate a control signal according to the switch signal and a predetermined comparison signal, so as to drive the fan for a rotational operation, and generating the feedback signal according to a conduction result of the fan, wherein the conduction result is realized via a voltage type or a current type to correspond to a rotational speed of the rotational operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional motor driving circuit.

FIG. 2 illustrates a detailed schematic diagram of the motor driving circuit shown in FIG. 1.

FIG. 3 illustrates a schematic diagram of a driving circuit according to an embodiment of the invention.

FIG. 4A to FIG. 4C illustrate detailed schematic diagrams of different control modules shown in FIG. 3 according to an embodiment of the invention.

FIG. 5 illustrates a detailed schematic diagram of the initiation module shown in FIG. 3 according to an embodiment of the invention.

FIG. 6 illustrates a detailed schematic diagram of the voltage transformation module and the feedback module shown in FIG. 3 according to an embodiment of the invention.

FIG. 7 illustrates a flow chart of a driving process according to an embodiment of the invention.

FIG. 8 illustrates a comparison schematic diagram of the invention and the prior art.

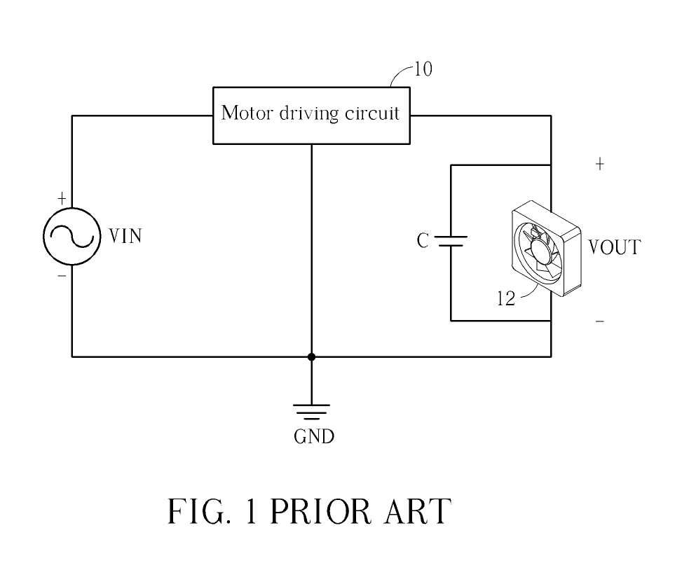

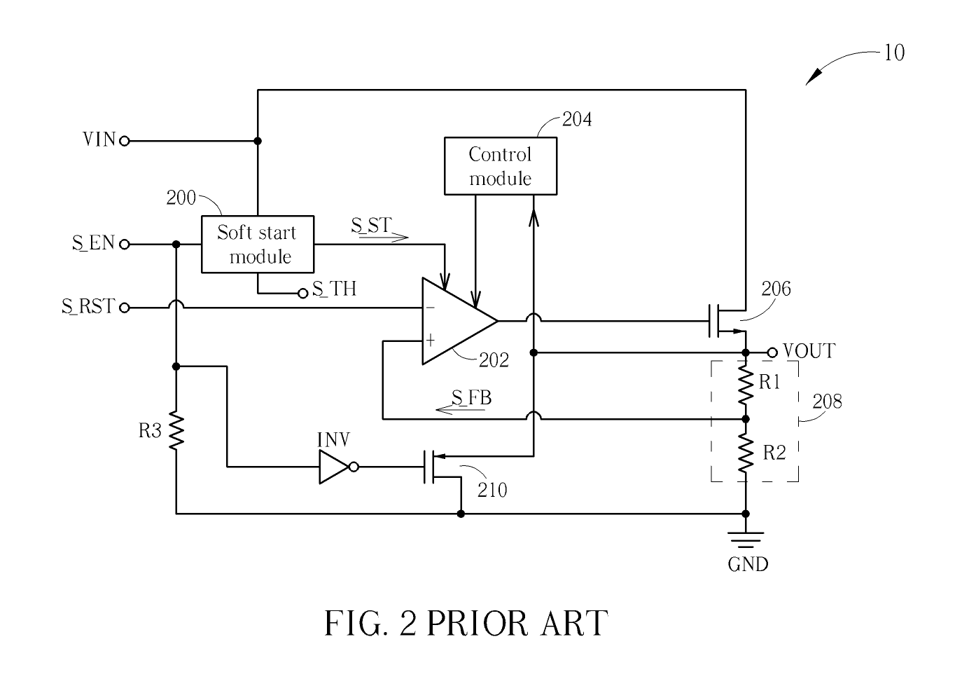

### DETAILED DESCRIPTION

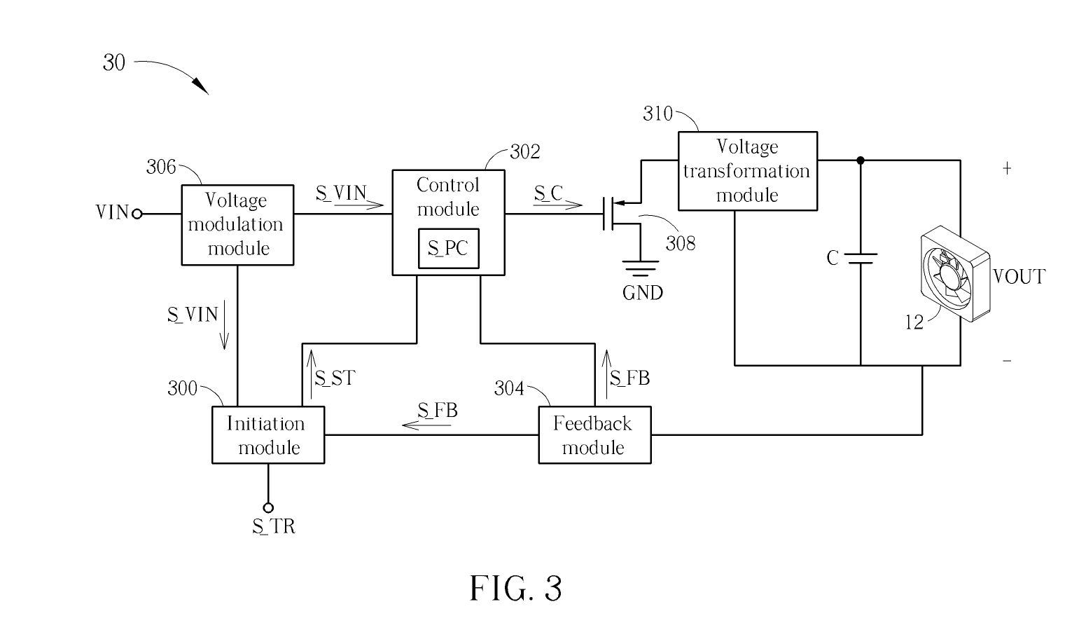

Please refer to FIG. 3, which illustrates a schematic diagram of a driving circuit 30 according to an embodiment of the invention, wherein a control module 302 of the driving circuit 30 utilizes the pulse frequency modulation (PFM) technique to correspondingly generate a transformed output voltage VOUT, so as to control a rotational operation of the fan 12. As shown in FIG. 3, the driving circuit 30 comprises an initiation module 300, the control module 302, a feedback module 304, a voltage modulation module 306, a switch transistor 308 and a voltage transformation module 310. The driving circuit 30 utilizes the voltage modulation module 306 to receive an input voltage VIN to generate a modulation input voltage S_VIN to the initiation module 300 and the control module 302. The initiation module 300 is coupled to the feedback module 304 to generate a switch signal S_ST according to a feedback signal S_FB generated by the feedback module 304. The control module 302 predetermines a predetermined comparison signal S_PC to compare a difference between the predetermined comparison signal S_PC and the feedback signal S_FB according to the switch signal S_ST and the modulation input voltage S_VIN, so as to output a control signal S_C. The switch transistor 308 is turned on/off according to the control signal S_C. The voltage transformation module 310 outputs the output voltage VOUT to the fan 12 and a stabilization capacitor C according to a conduction condition of the switch transistor 308, so as to drive the fan 12 for the rotational operation. In the meanwhile, the feedback module 304 correspondingly generates the feedback signal S_FB according to a conduction result of the fan 12, so as to dynamically process the operation of the initiation module 300 and the control module 302.

In simple, the control module 302 of the driving circuit 30 utilizes the PFM technique and predetermines the predetermined comparison signal S_PC, wherein the predetermined comparison signal S_PC can be realized as a limitation current signal S_CL or a constant timing signal S_FT. Further, the control module 302 compares the difference between the predetermined comparison signal S_PC and the feedback signal S_FB to generate the control signal S_C for correspondingly controlling the rotational operation of the fan 12, so as to change the rotational speed of the fan 12. Noticeably, the conduction result of the fan 12 can be realized via a voltage type or a current type, and both can be replaced with each other via Ohm's Law. If the conduction result of the fan 12 corresponds to a larger value of the voltage (current) type, the rotational operation of the fan 12 corresponds to a faster rotational speed. On the other hand, if the conduction result of the fan 12 corresponds to a smaller value of the voltage (current) type, the rotational operation of the fan 12 corresponds to a smaller rotational speed.

Furthermore, the limitation current signal S_CL or the constant timing signal S_FT can also be realized via a current (voltage) type, and can be pre-stored in the control module 302 according to the users' requirements or the environmental conditions, such that the PFM technique can utilize the limitation current signal S_CL or the constant timing signal S_FT as the determination for following operations. Preferably, the constant timing signal S_FT can be classified into a constant turning-on timing signal S_FXON and a constant turning-off timing signal S_FXOFF, so as to control the control module 302 when to be initiated or terminated. Besides, the PFM technique compares the difference between the feedback signal S_FB (i.e. the conduction condition of the fan 12) and the predetermined comparison signal S_PC (i.e. the limitation current signal S_CL or the constant timing signal S_FT) within a constant period to determine how much the energy passes through the fan 12, so as to determine whether or not to increase/decrease the energy passing through the fan 12. Under such circumstances, the user can adaptively pre-store the limitation current signal S_CL, the constant turning-on timing signal S_FXON or the constant turning-off timing signal S_FXOFF in the control module 302, and the control module 302 will process the comparison between the feedback signal S_FB as well as the limitation current signal S_CL, the constant turning-on timing signal S_FXON and the constant turning-off timing signal SFXOFF. Next, the control module 302 will wait for a while to see whether the feedback signal S_FB matches the limitation current signal S_CL, or whether the feedback signal S_FB matches one of the constant turning-on timing signal S_FXON and the constant turning-off timing signal S_FXOFF, and correspondingly outputs the control signal S_C while the feedback signal S_FB matches either one of the above situations. Certainly, those skilled in the art can modify the above signals to form different combinations for the comparison mechanism, so as to accurately determine how much the energy passes through the fan 12, which is also in the scope of the invention.

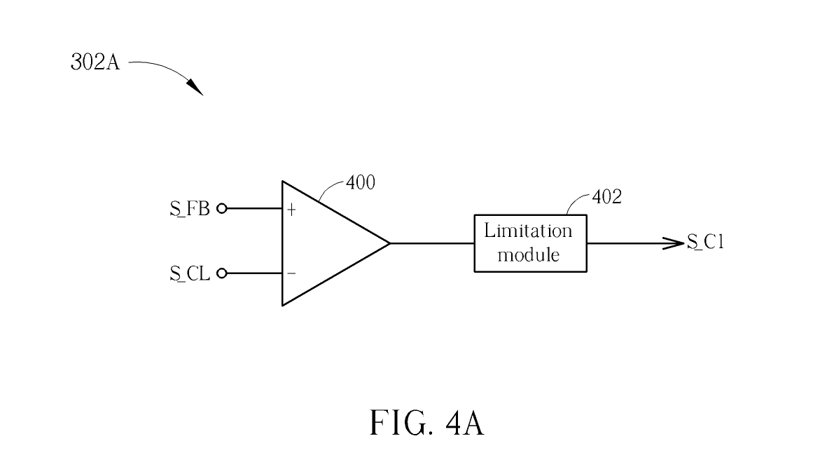

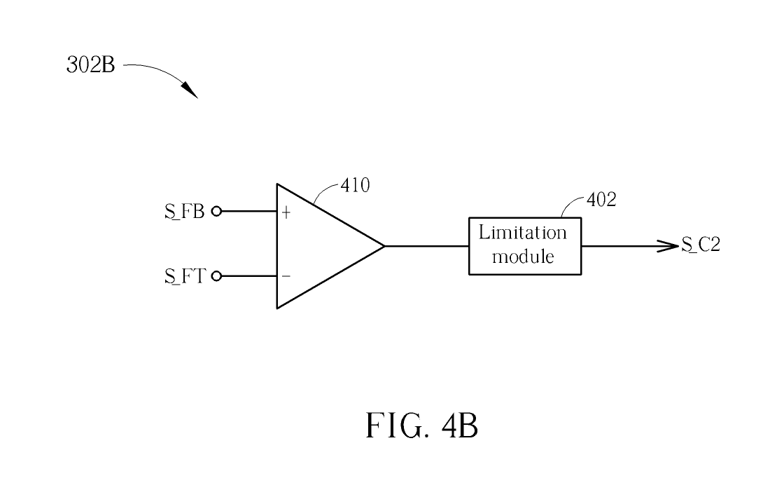

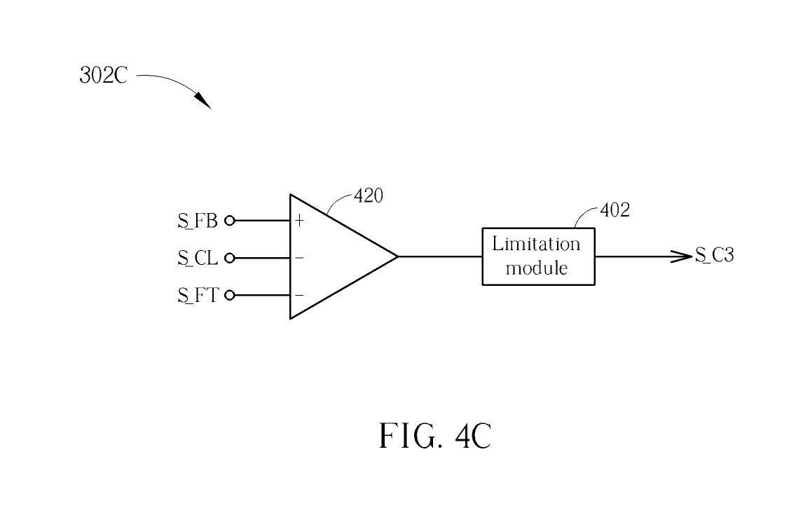

Please refer to FIG. 4A to FIG. 4C, which illustrate detailed schematic diagrams of different control modules shown in FIG. 3 according to an embodiment of the invention. As shown in FIG. 4A to FIG. 4C, the control modules 302A, 302B, 302C comprise the comparators 400, 410, 420, respectively, and each of the comparators 400, 410, 420 is coupled to a limitation module 402. In detail, the comparator 400 compares the difference between the feedback signal S_FB and the limitation current signal S_CL. The comparator 410 compares the difference between the feedback signal SFB and the constant timing signal S_FT, wherein the constant timing signal S_FT can be set as one of the constant turning-on timing signal S_FXON and the constant turning-off timing signal S_FXOFF. The comparator 420 simultaneously compares the differences between the feedback signal S_FB as well as the limitation current signal S_CL and the constant timing signal S_FT. In addition, the limitation module 402 outputs the control signals S_C1, S_C2, S_C3 according to comparison results belonging to the comparators 400, 410, 420 without limiting a predetermined current/voltage default, so as to correspondingly turn on/off the switch transistor 308.

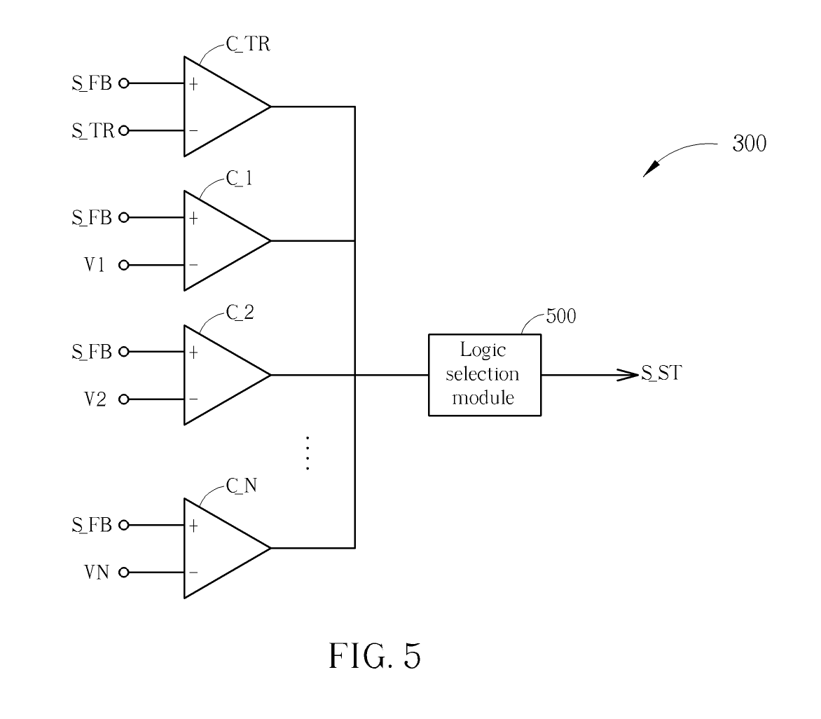

Please refer to FIG. 3, the initiation module 300 not only receives the modulation input voltage S_VIN and the feedback signal S_FB, but also receives a temperature parameter signal S_TR to correspondingly generate the switch signal S_ST. The temperature parameter signal S_TR is obtained with different values according to different rotational speeds of the fan 12, and can be realized via a current/voltage type as well. Under such circumstances, the initiation module 300 can determine whether the fan 12 is operated at a normal operation or an over-heating operation according to a current/voltage value of the temperature parameter signal S_TR. When the fan 12 is operated at the over-heating operation, the driving circuit 30 will be turned off. Please refer to FIG. 5, which illustrates a detailed schematic diagram of the initiation module 300 shown in FIG. 3 according to an embodiment of the invention. As shown in FIG. 5, the initiation module 300 comprises N numbers of comparators C_1, C_2, . . . , C_N and a temperature parameter comparator C_TR to be predetermined reference voltages V1-VN and the temperature parameter signal S_TR, respectively. By comparing a difference between the feedback signal S_FB as well as the reference voltages V1-VN and the temperature parameter signal S_TR, a logic selection module 500 will correspondingly output the switch signal S_ST.

Noticeably, the mentioned parameter N and practical values of the reference voltages V1-VN can be adaptively modified according to the users' requirements. In the embodiment, the reference voltages V1-VN form an incremental operational voltage range. Besides, the logic selection module 500 can be realized as a plurality of logic circuits in combination with a plurality of switch transistors, so as to output the comparison results belonging to the comparators C_1, C_2, . . . , C_N and the temperature parameter comparator C_TR as the switch signal S_ST to correspondingly control the conduction condition of the switch transistor 308.

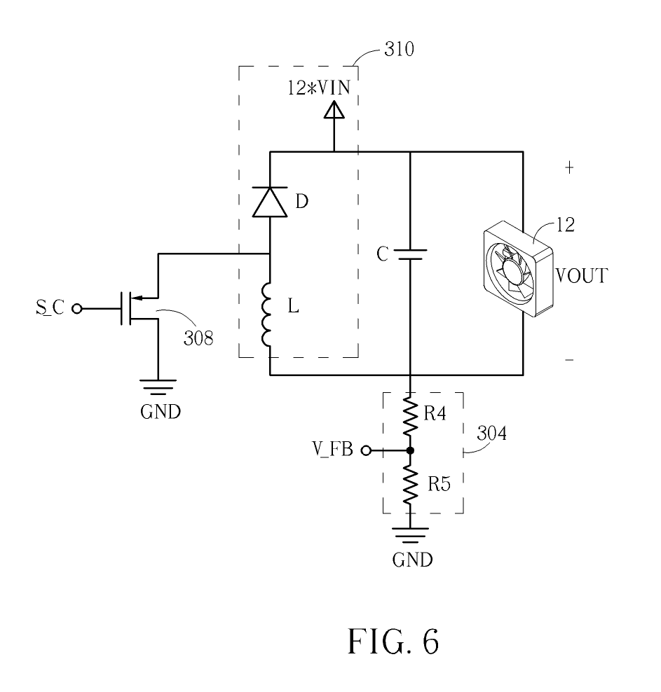

Please refer to FIG. 6, which illustrates a detailed schematic diagram of the voltage transformation module 310 and the feedback module 304 shown in FIG. 3 according to an embodiment of the invention. As shown in FIG. 6, the voltage transformation module 310 is a bootstrap circuit to be realized via a stable voltage source 12*VIN, a diode D and an inductor L. After the switch transistor 308 is conducted, the voltage transformation module 310 outputs different output voltages to drive the fan 12 with different rotational speeds. Certainly, those skilled in the art can design/modify the voltage transformation module 310 to be other types of buck converters or boost converters, so as to provide the fan 12 with a non-linear transformed output voltage, which is also in the scope of the invention. Additionally, the feedback module 304 is realized via division voltage resistors R4, R5, so as to generate different feedback signals according to different output voltages. Besides, the voltage modulation module 306 is utilized to transform the input voltage VIN into the modulation input voltage S_VIN, so as to provide a flexible value of the modulation input voltage S_VIN to drive the initiation module 300 and control module 302, respectively. The realization of the voltage modulation module 306 should be well known to those skilled in the art, and is not described hereinafter.

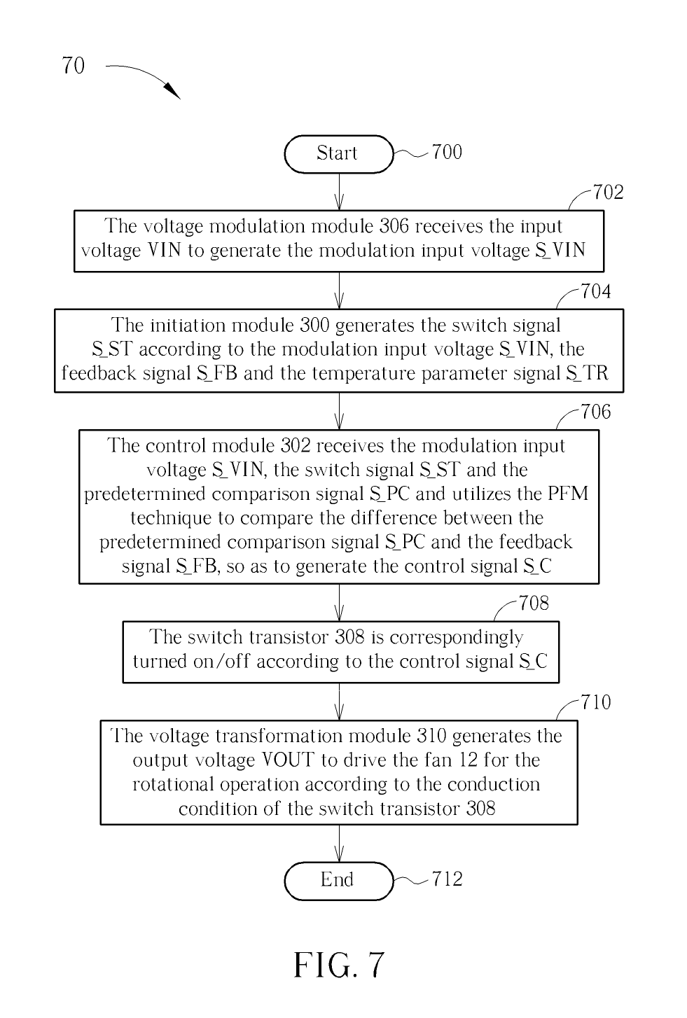

Further, the mentioned driving operation applied to the driving circuit 30 can be summarized as a driving process 70, as shown in FIG. 7. The driving process 70 includes the steps as follows.

Step 700: Start.

Step 702: The voltage modulation module 306 receives the input voltage VIN to generate the modulation input voltage S_VIN.

Step 704: The initiation module 300 generates the switch signal S_ST according to the modulation input voltage S_VIN, the feedback signal S_FB and the temperature parameter signal S_TR.

Step 706: The control module 302 receives the modulation input voltage S_VIN, the switch signal S_ST and the predetermined comparison signal S_PC and utilizes the PFM technique to compare the difference between the predetermined comparison signal S_PC and the feedback signal S_FB, so as to generate the control signal S_C.

Step 708: The switch transistor 308 is correspondingly turned on/off according to the control signal S_C.

Step 710: The voltage transformation module 310 generates the output voltage VOUT to drive the fan 12 for the rotational operation according to the conduction condition of the switch transistor 308.

Step 712: End

The detailed operation of the driving process 70 can be understood from the driving circuit 30, FIG. 3 to FIG. 6 and related paragraphs thereof, which is not described hereinafter. Noticeably, those skilled in the art can adaptively combine/modify the predetermined comparison signal S_PC mentioned in step 706, such as the limitation current signal S_CL, the constant turning-on timing signal S_FXON and the constant turning-off timing signal SFXOFF, so as to provide the combination/modification signals for the control module 302 to process the PFM technique. Thus, the energy passing through the fan 12 can be adaptively adjusted (i.e. the average current passing through the fan 12 within a unit time) to generate the non-linear transformed driving voltage to dynamically drive the fan 12 for different the rotational operations. Under such circumstances, the driving process 70 applied to the driving circuit 30 can comply with different users' requirements or different loading conditions, so as to be applied to a larger application field with better energy conversion efficiency.

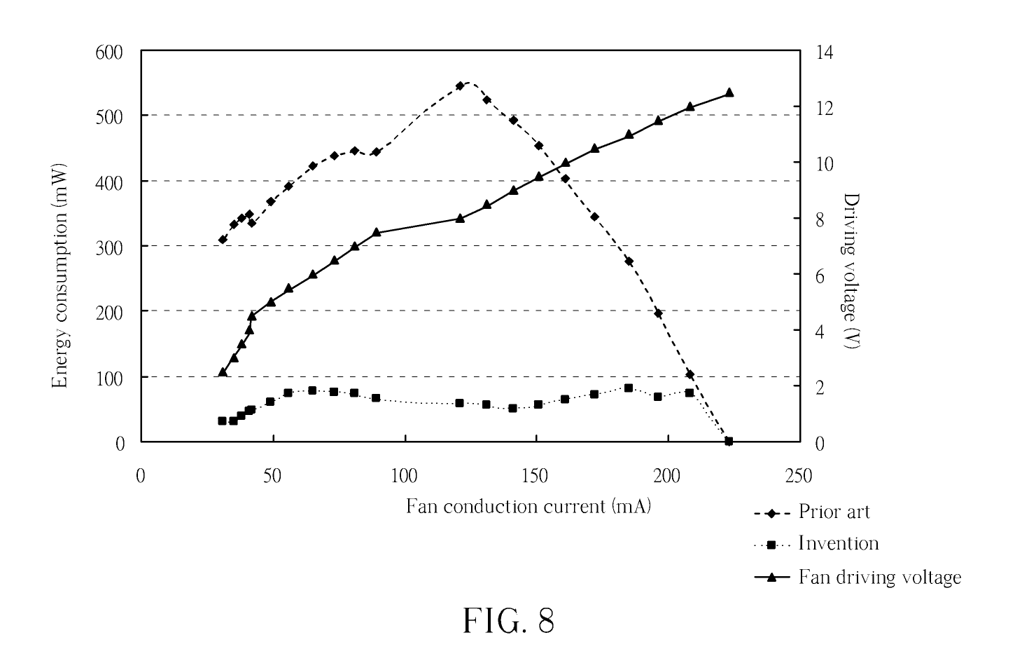

For example, please refer to FIG. 8, which illustrates a comparison schematic diagram of the invention and the prior art. In FIG. 8, the X-axis corresponds to a conduction current value of the fan 12 with the unit as micro Ampere (mA), the left of the Y-axis corresponds to a energy consumption during the rotational operation of the fan 12 with the unit as micro Watt (mW), and the right of the Y-axis corresponds to a voltage value for driving the fan 12 with the unit as Volt (V). As shown in FIG. 8, while the driving voltage for the fan 12 increases (corresponding to the solid line in the figure) to result in increasing of the conduction current as well, the prior art utilizes the linear voltage to drive the fan 12 for rotational operation (corresponding to the rhombus dotted line in the figure), and the invention utilizes the plurality of comparison parameters as well as the PFM technique to drive the fan 12 (corresponding to the square dotted line). Under such circumstances, the prior art renders larger energy consumption than the invention, and the energy consumption difference between the prior and the invention is 500 mW while the conduction current is 100 mA, which influences the operation of the fan 12 with the unnecessary heat generation. Certainly, those skilled in the art can utilize the concept of the driving circuit 30 and the driving process 70 to be combined with a pulse width modulation (PWM) technique accompanying other logic comparison circuits and software/firmware, so as to adaptively switch the fan 12 between the PFM or PWM technique to match different requirements, which is also in the scope of the invention.

In summary, the invention provides a driving circuit and method for a fan. By utilizing the pulse frequency modulation technique and a predetermined comparison signal, the invention compares a difference between a feedback signal and the predetermined comparison signal while the fan conducts, so as to adaptively adjust the energy passing through the fan to control a rotational speed thereof. In comparison with the prior art, the invention provides the non-linear transformed driving voltage to control the rotational operation of the fan to comply with different users' requirements with different loading/environmental conditions, so as to provide better energy conversion efficiency and broaden the application field of the driving circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit for a fan comprising:
an initiation module for generating a switch signal according to a feedback signal;
a control module coupled to the initiation module for generating a control signal according to the switch signal and a predetermined comparison signal, so as to drive the fan for a rotational operation; and
a feedback module coupled to the fan for generating the feedback signal according to a conduction result of the fan;
wherein the control module utilizes a pulse frequency modulation technique to generate the control signal, and the conduction result is realized via a voltage type or a current type to correspond to a rotational speed of the rotational operation.

2. The driving circuit of claim 1, wherein the predetermined comparison signal is a limitation current signal or a constant timing signal.

3. The driving circuit of claim 2, wherein the control module further comprises a comparator for comparing the limitation current signal and the conduction result of the fan to generate the control signal.

4. The driving circuit of claim 2, wherein the control module further comprises a comparator for comparing the constant timing signal and the conduction result of the fan to generate the control signal.

5. The driving circuit of claim 1, wherein the initiation module further generates the switch signal according to a temperature parameter signal of the fan.

6. The driving circuit of claim 1, further comprising a voltage modulation module coupled to the initiation module and the control module for receiving an input voltage.

7. The driving circuit of claim 1, further comprising a switch transistor to be turned on or off to render a conduction condition according to the control signal.

8. The driving circuit of claim 7, further comprising a voltage transformation module coupled to the fan and the switch transistor for generating different conduction results of the fan according to the conduction condition of the switch transistor, so as to generate different rotational speeds.

9. A method for driving a driving circuit of a fan, the method comprising:
generating a switch signal according to a feedback signal;
utilizing a pulse frequency modulation technique to generate a control signal according to the switch signal and a predetermined comparison signal, so as to drive the fan for a rotational operation; and
generating the feedback signal according to a conduction result of the fan;
wherein the conduction result is realized via a voltage type or a current type to correspond to a rotational speed of the rotational operation.

10. The method of claim 9, wherein the predetermined comparison signal is a limitation current signal or a constant timing signal.

11. The method of claim 10, further comprising comparing the limitation current signal and the conduction result of the fan to generate the control signal.

12. The method of claim 10, further comprising comparing the constant timing signal and the conduction result of the fan to generate the control signal.

13. The method of claim 9, further comprising generating the switch signal according to a temperature parameter signal of the fan.

14. The method of claim 9, further comprising utilizing a voltage modulation module for receiving an input voltage.

15. The method of claim 9, further comprising utilizing the control signal to control a conduction condition of a switch transistor.

16. The method of claim 15, further comprising utilizing the conduction condition of the switch transistor to generate different conduction results of the fan, so as to generate different rotational speeds.
